(19) United States
(12) Patent Application Publication
(10) Pub. No.: US 2016/0220051 A1
(43) Pub. Date: Aug. 4, 2016

(54) Drinking Straw with Flavored Insert

(71) Applicant: Claire Ellen CAHOON, Dallas, TX (US)

(72) Inventor: Claire Ellen CAHOON, Dallas, TX (US)

(21) Appl. No.: 14/610,514

(22) Filed: Jan. 30, 2015

(51) Int. Cl. A47G 21/18; A23L 1/237; A23L 2/56

(52) U.S. Cl. CPC A47G 21/183; A23L 2/56; A23L 1/237; A23V 2002/00

(57) ABSTRACT

A straw having a hollow core insert capable of imparting a flavor in a liquid that is sucked through the straw. The insert is made of a consumable material that is soluble in the liquid consumed through the straw. The insert is either co-manufactured with the straw or is manufactured as a separate insert that is placed into one end of the straw. The length of the insert is such that the liquid level in the straw is below the insert except when liquid is drawn into the straw by a consumer.

### BACKGROUND OF THE INVENTION

1. Technical Field

The present invention relates to a drinking straw for use with a drinkable fluid wherein an inner core of the straw imparts a flavor to the fluid as it passes through the straw before the liquid is drawn into the consumer's mouth. Specifically, the invention relates to a drinking straw having a flavored inner core insert, in one embodiment made of hard packed sodium chloride, that is soluble in the liquid being drawn through the straw. The straw eliminates the need for placing flavoring compounds around the mouth of the drinking vessel and provides the ability to induce flavors into a drink immediately prior to the drink being consumed.

2. Background of the Invention

Flavored drinks are quite popular, including flavored juices, flavored water, and flavored alcoholic drinks It is not always possible or ideal, however, to place particular flavoring within the liquid of the drink itself. An example of such drink is a salted margarita. A margarita is a common cocktail containing various flavor components including alcohol. An optional flavor component is salt, which is typically placed on the rim of the glass in which the margarita liquid is to be consumed. This allows for a burst of saltiness when a consumer drinks from a salted portion of the rim of the glass when drinking the margarita. Simply mixing the salt into the liquid in advance would not provide the same drinking experience.

It may also be desirable for a consumer to meter the amount of flavoring being consumed along with any base liquid. With the example of the margarita served in a glass with a salted rim, the consumer must ingest salt around the rim before an unsalted drink can be encountered. Thereafter, the consumer can alternate between a salted drink and an unsalted drink of the liquid from the glass.

Novel ways to add flavoring to drinks are frequently popular with consumers as well. An ability to use different flavor delivery mediums for the same base liquid is frequently quite desirable and marketable.

Drinking straws, typically of a polymer or paper construction, have been used for many years for the purpose of drawing a liquid into the mouth of a consumer. Prior art straws, however, normally serve no functionality other than to transport the liquid from the container in which the straw is inserted into the mouth of the consumer. A product sold by Reach Companies of Minneapolis, MN called “Magic Straws” does impart a flavor into a liquid, typically milk, drawn into the straw. However, the Magic Straws design is nothing more than dissolvable flavor beads placed inside a modified, thick straw. The Magic Straws product is designed with a physical barrier at each end of the modified straw which keeps the flavor beads in the body of the straw while allowing fluid to flow through the straw. The Magic Straws design requires a specially designed straw for this purpose, and the product must be sold pre-packaged with the flavor beads trapped inside the specially designed straw. Further, the flavor beads start to dissolve as soon as the straw is placed into the fluid.

Specifically, the Magic Straws concept involves taking a heavy gauge plastic straw and crimping a bottom portion of the straw to create a partial physical blockage in the straw. The straw is then substantially filled with dissolvable flavor beads having diameters larger than any remaining opening through the partial physical blockage in the straw. Finally, the straw is crimped at a top portion of the straw above the fill level of the flavor beads to again provide a partial physical blockage against bead migration. This design allows a fluid to flow through the Magic Straw while physically constricting the flavor beads from migrating outside the straw until they have sufficiently dissolved. However, the Magic Straw concept requires a thicker or heavier gauge straw in order to maintain the physical crimping at a top and bottom portion, requires the crimping and filling operation, and results in the flavor beads dissolving in any fluid as soon as the straw is placed in a liquid. Consequently, the addition of flavoring is not metered by the use of the straw, but is just a function of residence time of the flavor beads in the liquid median.

A need exists, therefore, for a new and novel approach for mixing a flavoring, such as a salt or a sugar-based compound, with a liquid immediately upon consumption. Such innovation should be relatively inexpensive and provide a flexible platform across many different drinking applications.

### SUMMARY OF THE INVENTION

In a preferred embodiment, the invention comprises a drinking straw having an insert consisting of consumable material that is hollow. The insert is located along only a portion of the length of the straw at the end of the straw through which the consumer will place his or her mouth. The straw insert should be located above the fluid level of the fluid to be consumed, such that fluid only contacts the insert when drawn upward through the straw by the consumer, thus allowing a metered application of flavoring to the fluid with every drink.

The insert can be co-manufactured with the straw or manufactured as a separate insert to be pressure-fit into the straw as a part of the manufacturing process or at a later date. The term “pressure fit” in this context means that the insert is mechanically forced into one end of a straw such that the physical contact between the exterior of the insert and the interior of the straw holds the insert in place.

The material used for the insert varies depending on the desired application, but is intended to slowly dissolve and mix with any liquid that passes through the insert without dissolving in the base liquid when the liquid is not being drawn through the straw. Examples of material that can be used in different embodiments of the invention include salt for use with margaritas and other drinks compatible with salt flavoring, a pepper and salt combination for bloody marys and similar drinks, sugar or artificial sweeter-based mixture, and other mixtures that create different flavoring and spice profiles with the consumption of the liquid.

In one embodiment, the insert protrudes slightly above the top rim of the straw when fitted into the straw. This feature allows for the consumer to experience the flavor provided by the insert simply by contacting the top of the straw with the consumer's tongue. Consumers can also meter the taste experience by alternating sips of the liquid through the straw with sips of the liquid through a straw not having an insert or the drink container itself

What is provided is a unique and novel invention that allows a consumer to meter the amount of flavoring being consumed along with any base liquid. One or more straws with such inserts can be used in tandem (two or more at a time) or serially (one after the other) depending on the desired flavor experience. The invention provides novel ways to add flavorings to drinks and an ability to use different flavored delivery medium to the same base liquid. Also provided is a new and novel approach for mixing a flavoring, such as salt or a sugar-based compounds, with liquid immediately upon consumption. The innovation provided is relatively inexpensive and provides a flexible platform across many different drinking applications.

### BRIEF DESCRIPTION OF THE DRAWINGS

The novel features believed characteristic of the invention are set forth in the appended claims. The invention itself, as well as a preferred mode of use, further objectives and advantages thereof, will be best understood by reference to the following detailed description of illustrative embodiments when read in conjunction with the accompanying drawings, wherein:

FIG. 1 is an illustration of a drinking straw using one embodiment of the insert of the invention;

FIG. 2 illustrates one embodiment of an insert of the invention; and

FIGS. 3a and 3b illustrate one embodiment of an ice mold relating to a frozen embodiment of the invention.

### DETAILED DESCRIPTION

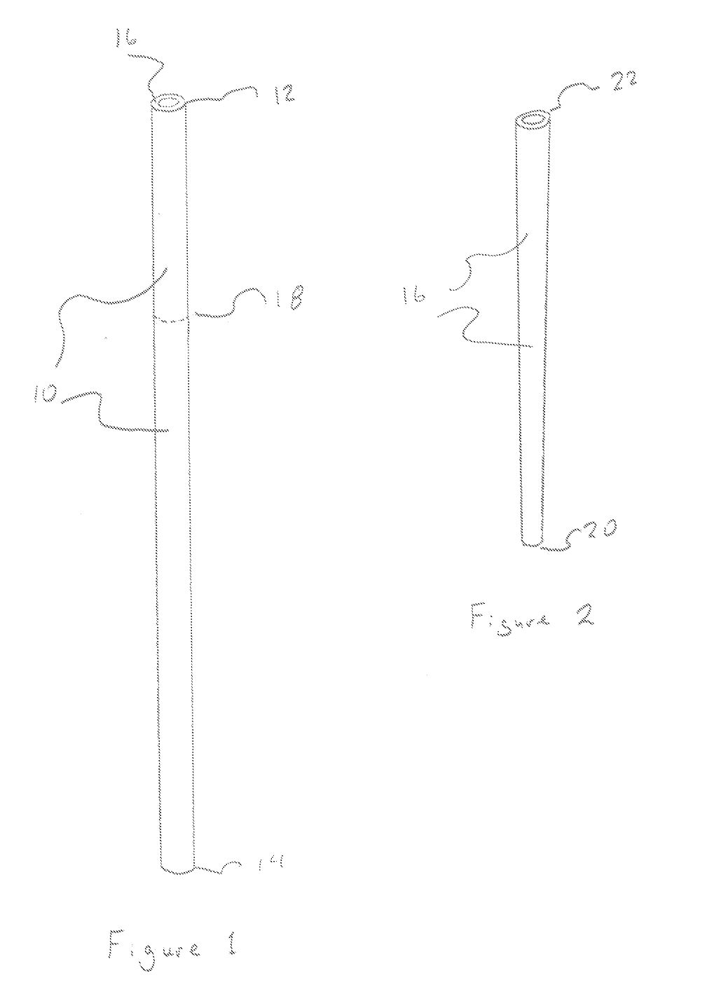

Referring to FIG. 1, shown is a typical straw 10 which can be manufactured from paper, a plastic or polymer material, metal, or any other suitable material known in the art. The straw 10 has an upper end 12 and a lower end 14. The straw 10 has an outer wall having a circumference and length and an inner wall (not shown) having a circumference and length. The straw 10 is tubular throughout, meaning there is no crimping along any portion of the straw 10. In use, and by way of reference, the lower end 14 is placed into a container having a drinkable fluid. This container can be a cup, a glass, a bottle, a jug, or any other container capable of holding a fluid for the purpose of drinking the fluid through a straw.

Also shown in FIG. 1 is an insert having a hollow core 16 located at the first end 12 of the straw 10. This hollow core insert 16 only extends along a length of the straw 10 to a certain point 18 illustrated as an example in FIG. 1 by a dashed line 18 along the exterior of the straw 10 representing the internal end position of the hollow core insert 16. It should be understood that the dashed line 18 is for illustrative purposes only and would not be visible on the exterior of the straw 10. It should also be noted that in an alternative embodiment of the invention, the insert 16 extends along the entire length of the straw 10. In fact, it is contemplated that the insert 16 can be of any given length relative to the straw 10 up to and slightly longer than the total length of the straw 10. However, the preferred use of the invention involves keeping the insert 16 out of the fluid level of the base fluid except when the fluid is drawn into the straw 10. This feature meters the addition of flavoring to the fluid when consumed and limits adulteration of the fluid with flavoring while the straw sits in the fluid. The preferred embodiment uses an insert 16 that is at least less than half as long as the straw 10. For example, when used in combination with an eight inch long straw 10, the preferred embodiment uses an insert that is less than four inches in length placed in the upper portion of the straw 10. Shorter straws used for mixed drinks, such as a six inch straw, would use as a preferred embodiment an insert of less than three inches. A more preferred embodiment uses an insert of between one inch and three inches such that it is easily adaptable to a number of straw lengths and stays out of the in situ liquid level of the straw when in use.

Returning to the hollow core insert 16, (hereinafter referred to as the “insert” 16), the insert 16 is illustrated as being within the straw 10 in contact with the circumference of the inner surface of straw 10 (not shown). The insert 16 is also illustrated in FIG. 1 as being relatively flush on its exposed end with the first end 12 of the straw 10. In an alternative embodiment, the insert 16 protrudes slightly above the straw 10 such that the flavor imparted by the insert 16 can be tasted by the consumer upon placing his or her mouth on the straw 10 before any liquid is drawn into the straw 10. This slight protrusion is between flush with (meaning the top 22 of the insert 16 and the top 12 of the straw 10 are in the same horizontal plane) and one inch above the top end 12 of the straw 10.

The insert 16 can be co-manufactured with the straw 10, inserted into the straw 10 as a part of the manufacturing process, or can be a separate insert that is physically placed into the straw 10 prior to using the straw 10. The latter concept is illustrated in FIG. 2, and allows for the storage of inserts 16 for use with standard straws at a later date immediately prior to drinking a fluid through the straw 10. Shown is an insert 16 that is slightly tapered from a top or exposed portion 22 to the bottom portion 20. A hollow core will be present throughout the insert from the top 22 to the bottom 20. The diameter of the insert 16 at the upper end 22 is greater than the diameter of the insert 16 at the bottom portion 20, thereby giving the insert 16 a tapered shape. This tapering of the insert 16 is a preferred embodiment when the insert 16 is a separate component placed into the straw 10 prior to the straw 10 being used. Further, in a preferred embodiment, the outer diameter of the insert 16 at the exposed end 22 is slightly greater than the interior diameter of the straw 10 in which it will be used. Further, the outer diameter of the opposite end 20 of the insert 16 is slightly less than the interior diameter of the straw 10 in which it will be used. This geometry allows for a physically snug pressure fit of the insert 16 into the top of the straw 10 and easy insertion therein when the straw 10 and the insert 16 are separately manufactured components. In a preferred embodiment, the outside diameter of the straw 10 is approximately the same as the outside diameter of the widest end 22 of the insert 16, thus the portion, if any, of the insert that protrudes from the top of the straw 16 appears seamless with the straw 10 itself.

When using a straw 10 that is relatively flexible, such as straws commonly made with polymer material, the amount of the insert 16 that can remain exposed above the top end 12 of the straw 10 can be adjusted by the amount of pressure used to push the insert 16 into the straw 10. For example, it may be desirable to leave a small portion, such as ¼ inch, of the insert 16 above the upper portion 12 of the straw 10. In the embodiment using salt as the main ingredient for the insert 16, this provides for a salted glass margarita-like experience when drinking through a straw having such arrangement.

In order to slow the solubility of the insert 16 when in use, it may be preferable to compress the material used in the insert 16 and/or include a food-grade binder with the material. Using the example of an insert 16 consisting of sodium chloride, such sodium chloride is compressed into a solid piece, thereby reducing its solubility. In another embodiment, food-grade binders, such as known in the art, are added to the sodium chloride in order to further reduce its solubility, such as is the case with salt licks commonly used for livestock.

In an alternative embodiment, the insert 16 can have other flavoring compounds and can be either savory or sweet. For example, the insert 16 can comprise sugar, spices, and other flavorings alone or in combination. It should further be understood that the invention can be used with any number of liquid combinations, including simple water and dairy products. Using the straw 10 with a flavored insert 16 can provide for an instant flavored drink, the flavor imparted depending upon the consumable material used in the insert 16. Consequently, it is contemplated that the instant invention can be used as an instrument for flavoring many drinkable platforms, including alcoholic drinks, soft drinks, fruit juices, sport drinks, and drinks that are either hot or cold when served.

In addition to the separate insert 16 illustrated in FIG. 2, it should be understood that applicant's invention includes an insert 16 that is co-manufactured with the straw 10, and thus affixed during the manufacturing process within the straw 10. Thus, applicant's use of the term “insert” 16 is not limited to instances when the insert 16 is placed in the straw 10 after the straw is manufactured.

The co-manufacturing of the straw 10 and the insert 16, in one embodiment, involves co-extrusion of the straw material along with the inner core insert 16. The extrusion process involves an outer, circular extrusion orifice through which a polymer material flows, an intermediate extrusion spray onto the interior of the formed polymer tube, and an air stream that is blown through the tube used to dry the core material and maintain the straw in a tube configuration until it is formed and cut, by methods known in the art.

Another embodiment of the insert 16 consists of a frozen material, such as frozen flavored water. Inserts 16 made for this embodiment can be constructed by the use of ice molds and other means known in the art.

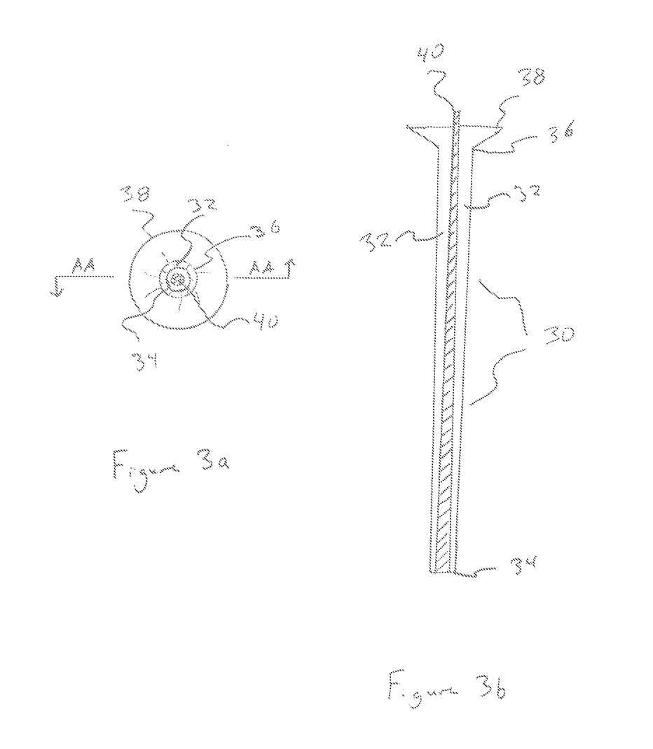

Referring to FIGS. 3a and 3b, one embodiment of a mold 30 used to form an ice insert in accordance with one embodiment of the invention is illustrated. FIG. 3a is a top plan view of the mold 30, while FIG. 3b is a cut away, side view of the mold 30 illustrating the internal dimensions of the mold. FIG. 3b illustrates the tube as sliced in half along the line AA shown in FIG. 3a. This allows a view of the internal dimensions in rough approximately in FIG. 3b.

The mold 30 consists of a central hollow channel 32 in which a liquid is poured through a funneling opening 38 at or near the top portion 36 of the open tube 32. The tube 32 is closed at the bottom 34. It can be seen that the open tube 32 is wider at the top 36 than at the bottom 34. Thus, the open tube 32 tapers from the top 36 to the bottom 34.

Affixed to the bottom of the tube 34 is an internal spindle 40. This spindle is a solid piece that attaches to the bottom 34 of the tube 32 and extends above the funnel-shaped opening 38. When a fluid is poured into the funnel-shaped opening 38, it fills the hollow tube 32 and surrounds the spindle 40. It should also be noted that the spindle 40 is tapered in the opposite direction as the tube 32. Specifically, the spindle is wider at its base at the bottom of the tube 34 as opposed to its top as it protrudes above the funnel-shaped portion 38.

In a preferred embodiment, the mold shown in FIGS. 3a and 3b is constructed of a metal, such as aluminum. Further, FIGS. 3a and 3b illustrate a single mold 30. It is contemplated that in a preferred embodiment, such mold will be arrayed in rank and column and attached to each other such that a number of molds can be filled simultaneously from the top of the array (for example, a tray with two columns of molds ten ranks deep, resulting in an ice tray type piece having twenty molds 30 all in one unit), with the funnel-shaped portion 34 morphing into a square shape in the horizontal plane such that a sheet of openings is provided.

The metal construction of a preferred embodiment of the tube 32 promotes the removal of the insert once it is frozen. As noted previously, the tube 32 is tapered from the bottom 34 being narrower to the top 36 being wider. The converse is the case for the spindle 40. This geometry provides that when a water-based liquid begins to freeze, as it transitions from a liquid to a solid, it expands and causes the forming insert to push upward in the mold. Further, without limitation on the functionality of the mold 30, it is believed that the metal construction also shrinks slightly in each dimension further assisting in the formed frozen insert rising to the top of the mold 30. Once the insert is completely frozen, warm water can be run on the exterior of the mold 30 and the frozen insert easily removed by finger and slid over the spindle 40.

The foregoing is merely illustrative of the principles this invention, and various modifications can be made by those skilled in the art without departing from the scope and spirit of the invention. It should be understood, for example, that the straw 10 and insert 16 described herein can be used in any number of applications and in any number of configurations consistent with the general principles of the invention. Various embodiments of the insert 16 contemplate a number of materials that can be used, including hard candy, compacted sodium chloride, ice, and various mixtures of food-grade salts, sugars, and flavoring compounds, such as, but not limited to, salts, sugars and sugar substitutes, salt and pepper, hard peppermint candy, hard lemon drop candy, soft caramel candy, soft chocolate candy, lemonade flavoring, orange flavoring, sour flavoring, jalapeno and other hot spice flavoring, cinnamon flavoring, nutmeg flavoring, vanilla flavoring, and strawberry flavoring.

While this invention has been particularly shown and described with reference to preferred embodiments, it will be understood by those skilled in the art that various changes in form and detail may be made therein without departing from the spirit and scope of the invention. The inventor expects skilled artisans to employ such variations as appropriate, and the inventor intends the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A drinking straw comprising:
an outer wall having a circumference and length;
an inner wall having a circumference and length;
a hollow core insert in contact with the circumference of the inner wall and extending along at least a portion of the length of the inner wall, wherein said hollow core insert is soluble in a drinkable liquid.

2. The drinking straw of claim 1 wherein the hollow core insert comprises sodium chloride.

3. The drinking straw of claim 1 wherein the hollow core insert comprises a food grade binding agent.

4. The drinking straw of claim 1 wherein the hollow core insert is co-manufactured with the straw.

5. The drinking straw of claim 1 wherein the hollow core insert consists of an insert placed in the straw after manufacture of the straw.

6. The drinking straw of claim 5 wherein the hollow core insert is tapered.

7. The drinking straw of claim 1 wherein the hollow core insert comprises a flavoring agent.

8. The drinking straw of claim 1 wherein the hollow core insert protrudes above one end of the straw.

9. The drinking straw of claim 1 wherein the insert is at least less than half as long as the straw.

10. An insert for a drinking straw, said insert comprising:
a solid tube of consumable material, wherein said material is soluble in a drinkable liquid.

11. The insert of claim 10 wherein the consumable material comprises sodium chloride.

12. The insert of claim 10 wherein the consumable material comprises a food-grade binding agent.

13. The insert of claim 10 wherein the insert tapers from one end to another.

14. The insert of claim 10 wherein the consumable material comprises a flavoring agent.

15. The insert of claim 10 wherein the consumable material comprises frozen water.

16. A method for consuming a flavored drink, said method comprising the steps of:
a) obtaining a drinking straw having a flavored consumable hollow core insert along an upper length of the straw;
b) inserting the drinking straw into a drinkable liquid such that the liquid level in the straw is below the flavored consumable core; and
c) sucking on the straw, thereby drawing the drinkable liquid through the flavored consumable core.

17. The method of claim 16 wherein step a) further comprises inserting a flavored consumable hollow core insert into an upper portion of a drinking straw, thereby forming the drinking straw having a flavored consumable core.
